(19) United States
(12) Patent Application Publication
(10) Pub. No.: US 2008/0234026 A1
(43) Pub. Date: Sep. 25, 2008

(54) Midi in a Wagering Game Machine

(76) Inventor: Paul Radek, Naperville, IL (US)

Correspondence Address: SCHWEGMAN, LUNDBERG & WOESSNER/WMS GAMING, P.O. BOX 2938, MINNEAPOLIS, MN, 55402, US

(21) Appl. No.: 11/596,029

(22) PCT Filed: Dec. 7, 2004
(86) PCT No.: PCT/US04/40890

§ 371 Date: Aug. 20, 2007

Related U.S. Application Data
(60) Provisional application No. 60/570,553, filed on May 13, 2004.

(51) Int. Cl. A63F 9/24; A63F 13/00; G06F 19/00

(52) U.S. Cl. 463/16; 463/20; 463/35

(57) ABSTRACT

A computerized gaming system has a gaming module that includes a processor and gaming code which is operable when executed on the processor to conduct a reel slot machine wagering game on which monetary value can be wagered. An audio module is operable to play audio by reading a musical instrument digital interface (MIDI) score comprising symbols representing sounds and by playing the sounds represented in the MIDI score.

### FIELD OF THE INVENTION

The invention relates generally to wagering gaming systems, and more specifically to computerized wagering game machines employing a Musical Instrument Digital Interface (MIDI).

### BACKGROUND OF THE INVENTION

A wide variety of gaming devices are now available to gamers and to casino operators in computerized form, from slot machines to games that are traditionally played live such as poker and blackjack. These computerized games provide many benefits to the game owner and to the gambler, including greater reliability than can be achieved with a mechanical game or human dealer, more variety, sound, and animation in presentation of a game, and a lower overall cost of production and management.

Computerized video game systems must be designed with many of the same concerns as their mechanical and table game ancestors—they must be fair, they must provide sufficient feedback to the gamer to make the game fun to play, and they must meet a variety of gaming regulations to ensure that both the machine owner and gamer are honest and fairly treated in implementing the game. Further, they must provide a gaming experience that is at least as attractive as the older mechanical gaming machine experience to the gamer, to ensure success in a competitive gaming market.

Many computer elements have been employed in gaming systems, from computerized animation to playing prerecorded sounds through a gaming system's speakers. These are carefully designed, along with the general theme and other elements of a gaming system, to attract the attention of gamers and to provide a memorable gaming experience. The audio track in particular often includes prerecorded music and sound effects, which are typically stored in standard formats such as standard .wav or .mp3 files, and that are played back at appropriate times. Unfortunately, storing prerecorded music takes a significant amount of space, which becomes even more critical in gaming systems that employ relatively expensive storage mechanisms such as flash memory rather than hard disk drives. Storage is in many circumstances not a matter of simply adding a larger, more expensive hard disk drive, as regulations concerning the security and integrity of gaming code and related files in computerized gaming systems dictate certain measures of security be maintained.

It is therefore desirable to employ a method of storing audio in a computerized wagering game system that reduces the demand on storage placed by traditional prerecorded music storage formats.

### SUMMARY OF THE INVENTION

The present invention provides in one embodiment a computerized gaming system having a gaming module that includes a processor and gaming code which is operable when executed on the processor to conduct a reel slot machine wagering game on which monetary value can be wagered. An audio module is operable to play audio by reading a musical instrument digital interface (MIDI) score comprising symbols representing sounds and by playing the sounds represented in the MIDI score.

### BRIEF DESCRIPTION OF THE FIGURES

FIG. 1 shows a computerized reel slot gaming system having an audio module consistent with an embodiment of the present invention.

FIG. 2 is a flowchart showing a method of practicing an example embodiment of the present invention.

### DETAILED DESCRIPTION

In the following detailed description of sample embodiments of the invention, reference is made to the accompanying drawings which form a part hereof, and in which is shown by way of illustration specific sample embodiments in which the invention may be practiced. These embodiments are described in sufficient detail to enable those skilled in the art to practice the invention, and it is to be understood that other embodiments may be utilized and that logical, mechanical, electrical, and other changes may be made without departing from the spirit or scope of the present invention. The following detailed description is, therefore, not to be taken in a limiting sense, and the scope of the invention is defined only by the appended claims.

The present invention provides in one embodiment a computerized gaming system having a gaming module that includes a processor and gaming code which is operable when executed on the processor to conduct a reel slot machine wagering game on which monetary value can be wagered. An audio module within the gaming machine is operable to play audio by reading a musical instrument digital interface (MIDI) score comprising symbols representing sounds and by playing the sounds represented in the MIDI score. This enables the gaming machine to store a score comprising symbols representing music and other sounds, rather than requiring the machine to store a significantly larger recording of the desired audio to be played.

In one embodiment of the invention, the score takes toe form of a MIDI file, which contains symbols representing the various sounds to be played. MIDI is an acronym for musical instrument digital interface, a standard adopted by the electronic music industry for controlling devices, such as synthesizers and sound cards, that produce music and other sounds. A MIDI representation of a sound typically includes values for the note's pitch, length, and volume, but can also include additional characteristics, such as attack and delay time.

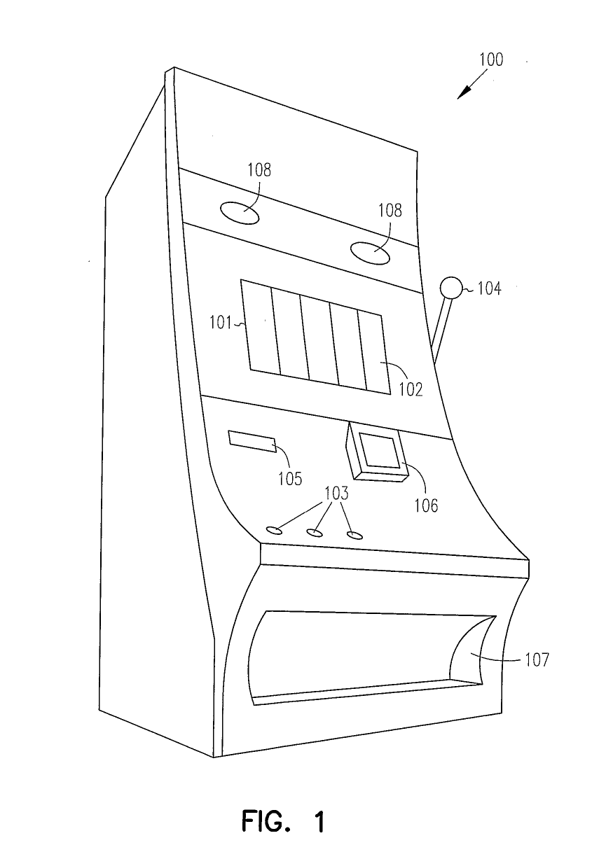

An example of a gaming machine employing such an audio module is shown in FIG. 1. The computerized gaming system shown generally at 100 is a video gaming system, which displays information for at least one wagering game upon which monetary value can be wagered on video display 101. Alternate embodiments of the invention will have other game indicators, such as mechanical reels instead of the video graphics reels 102. The game of chance is played and controlled with various buttons 103, and in some embodiments also with a pull arm 104 to initiate reel spin. Value is wagered on the games, such as with tokens, coins, bills, or cards that hold value. The wagered value is conveyed to the machine through a changer 105 or a card reader 106, and winnings are returned via the returned value card or through the coin tray 107. The audio module reads a score or other data structure representing sounds to be played, such as a MIDI file, and creates the audio signal that is played through speakers 108.

This example embodiment of the invention uses MIDI to represent the sounds to be played due to the relative popularity of the MIDI format, and the ease with which MIDI files may be produced and managed. The MIDI standard is supported by most synthesizers, so sounds created on one synthesizer can be played and manipulated on another synthesizer, computer, or wagering game machine. Computers that have a MIDI interface can record sounds created by a synthesizer and then manipulate the data to produce new sounds. For example, a producer of a MIDI file could change the key of a composition with a single keystroke, could create a file that loops or repeats certain parts, and perform other such functions using commonly available software. Further, a number of software programs are available for composing and editing music that conforms to the MIDI standard, and offer a wide variety of composition functions. For example, when a musician plays a melody on a keyboard connected to a computer via a MIDI interface, a music program can translate what is played into a MIDI score. The widespread MIDI support in composition software reduces the burden of producing and formatting content, and so is used as an example here.

Other embodiments of the invention will use other symbols or scripts to represent various notes or sounds to be played. Such representative symbols range from complex, such as MDI, to very simple, such as simply naming a note and duration. A “C” note played as a quarter note may be simply represented in a script with the symbol “C4”, for example, or may be represented as “5C4”, where 5 represents a specific octave. More complex scripts will add commands for changing volume, specifying specific instruments or sounds to be played back, attack/decay rates, and the like. Still further embodiments include the ability to play multiple notes and multiple instruments at the same time, enabling a more complex and rich audio presentation.

Sound effects are also represented by symbols in the scripting language in some embodiments, including the MIDI example described in detail above. Some MIDI instruments are defined such that they are not really a single instrument, but such that each note represents a different sound effect rather than a different note from the same instrument. MIDI instruments can further either be one of a standard instrument type, or can be defined by the user. This enables playing a wide range of sound effects in various complex arrangements by simply defining a MIDI instrument or using a preexisting MIDI instrument having the desired sound effects, and creating a MIDI score comprising symbols representing the various sound effects to be played. Embodiments not employing MIDI can represent sound effects even more simply, such as with a single character where a sufficiently small number of sounds are to be referenced, or by using more complex symbolic notation.

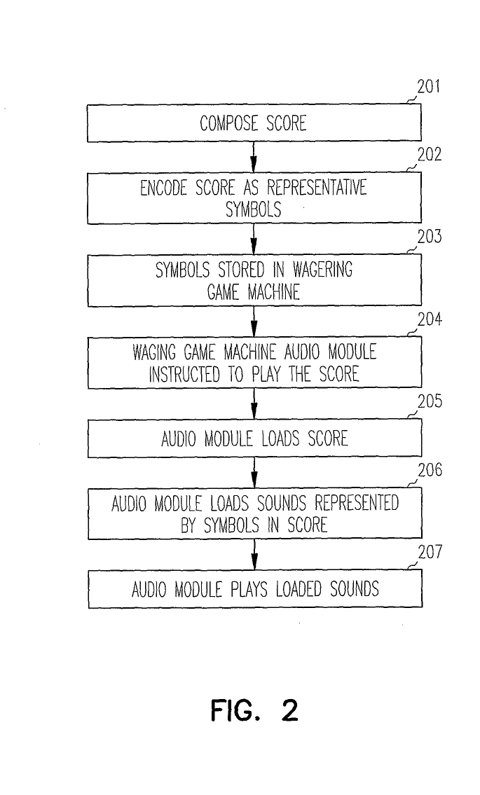

FIG. 2 is a flowchart of a method of practicing one example embodiment of the present invention. At 201, a developer composes a score comprising music, sound effects, or other sounds to be played. At 202, the score is encoded using symbols representing the various sounds to be played, which are then stored in a computerized wagering game machine at 203. At this point, the wagering game machine is used, and an audio module within the gaming machine is instructed to play the score comprising the encoded representative symbols at 204. The audio module in various embodiments of the invention will be embodied in hardware, software, or some combination of hardware and software to provide the functionality described. At 205, the audio module loads the score if it is not yet loaded, and also loads the sounds represented by the symbols in the score if needed at 206.

Although the symbols are loaded from storage within the wagering game machine in this example, such as from flash memory or from a hard disk drive, other embodiments of the invention will feature other methods of delivery such as via a network connection. Such as system would enable remote control and coordination of music played across one or several wagering game machines, and do so using a relatively efficient method of conveying the sounds to be played to each of the wagering game machines. Because sending symbols representing sounds will take less bandwidth than sending the sounds themselves, use of the present invention in such an environment may enable network distribution of an audio score in an environment where it was not previously possible or practical.

Such a system would further enable a particular bank of wagering game machines to play the same song at the same time. In a further embodiment, the wagering game machines will play different sounds that contribute to the overall presentation of audio, much like individual instruments or sections in an orchestra. Surround sound effects, coordinated distribution of sound effects relating to a theme of a bank of wagering games, and other such effects are further made possible by various embodiments of the invention. In further embodiments, symbols such as are available in MIDI or other symbolic formats will be used to control one or more peripheral devices, such as lights on a top-box, either on a single machine or across a group of networked machines.

The sounds represented by symbols in the score are in some embodiments prerecorded sounds such as sound effects, while in other embodiments are synthesized sounds that are not simply played but are in a sense created. Various parameters are used to define the way a sound is synthesized, and many variations exist within the broad field of sound and music synthesis. In embodiments where the sound is synthesized rather than simply played as a prerecorded sound, the synthesis parameters rather than a recording of the sound are loaded at 206.

At 207, the audio module plays the loaded sounds according to the symbols in the score. The audio is played through speakers 108, and is presented to the game player as part of the presentation of the wagering game. In further embodiments of the invention, sounds are played using representative symbols such as those within a MIDI file for other applications within wagering game machines, such as to attract game players while a wagering game machine is not being played but is in an attract mode. It is anticipated that the present invention will be applicable to many other uses within a wagering game machine, and will provide the same benefits of compact and efficient representation of a wide range of complex music and sound effects as are explained in the examples given here.

The embodiments of the present invention presented here illustrate by way of example how symbols such as those stored in a MIDI file may be used to represent sounds that are played either as a prerecorded sound or as a synthesized sound in a wagering game machine. Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations of the invention. It is intended that this invention be limited only by the claims, and the fall scope of equivalents thereof.

1. A computerized gaming system, comprising:
a gaming module, comprising a processor and gaming code which is operable when executed on the processor to conduct a wagering game on which monetary value can be wagered; and
an audio module, the audio module operable to play audio by reading a score comprising symbols representing sounds and by playing the sounds represented in the score.

2. The computerized gaming system of claim 1, wherein playing the sounds represented in the score comprises playing synthesized sounds.

3. The computerized gaming system of claim 1, wherein playing the sounds represented in the score comprises playing prerecorded sounds.

4. The computerized gaming system of claim 1, wherein the score comprises a musical instrument digital interface (MIDI) score.

5. The computerized gaming system of claim 4, wherein the audio module comprises a MIDI interpreter.

6. The computerized gaming system of claim 1, wherein the audio module is further operable to play multiple scores concurrently.

7. The computerized gaming system of claim 1, wherein the audio module is further operable to play multiple sounds from the same score concurrently.

8. The computerized system of claim 1, wherein the computerized wagering game comprises a reel slot game.

9. The computerized system of claim 1, wherein the score is received in the computerized gaming system via a network connection.

10. A method of operating a computerized gaming system, comprising:
playing audio by reading a score comprising symbols representing sounds and by playing the sounds represented in the score via an audio module of the computerized gaming system, wherein the computerized gaming system further comprises a gaming module comprising a processor and gaming code which is operable when executed on the processor to conduct a wagering game on which monetary value can be wagered.

11. The method of claim 10, wherein playing the sounds represented in the score comprises playing synthesized sounds.

12. The method of claim 10, wherein playing the sounds represented in the score comprises playing prerecorded sounds.

13. The method of claim 10, wherein the score comprises a musical instrument digital interface (MIDI) score.

14. The method of claim 13, wherein the audio module comprises a MIDI interpreter.

15. The method of claim 10, wherein the audio module is further operable to play multiple scores concurrently.

16. The method of claim 10, wherein the audio module is further operable to play multiple sounds from the same score concurrently.

17. The method of claim 10, wherein the computerized wagering game comprises a reel slot game.

18. The method of claim 10, wherein the score is received in the computerized gaming system via a network connection.

19. A machine-readable medium with instructions stored thereon, the instructions when executed operable to cause a computerized wagering game system to:
play audio by reading a score comprising symbols representing sounds and by playing the sounds represented in the score via an audio module of the computerized gaming system, wherein the computerized wagering game system further comprises a gaming module comprising a processor and gaming code which is operable when executed on the processor to conduct a wagering game on which monetary value can be wagered.

20. The machine-readable medium of claim 19, wherein playing the sounds represented in the score comprises playing synthesized sounds.

21. The machine-readable medium of claim 19, wherein playing the sounds represented in the score comprises playing prerecorded sounds.

22. The machine-readable medium of claim 19, wherein the score comprises a musical instrument digital interface (MIDI) score.

23. The machine-readable medium of claim 22, wherein the audio module comprises a MIDI interpreter.

24. The machine-readable medium of claim 19, wherein the audio module is further operable to play multiple scores concurrently.

25. The machine-readable medium of claim 19, wherein the audio module is further operable to play multiple sounds from the same score concurrently.

26. The machine-readable medium of claim 19, wherein the computerized wagering game comprises a reel slot game.

27. The machine-readable medium of claim 19, wherein the score is received via a network connection.

28. A computerized gaming system, comprising:
a gaming module, comprising a processor and gaming code which is operable when executed on the processor to conduct a reel slot wagering game on which monetary value can be wagered; and
an audio module, the audio module operable to play audio by reading a musical instrument digital interface (MIDI) score comprising symbols representing sounds and by playing the sounds represented in the score.

29. The computerized gaming system of claim 28, wherein the computerized gaming system farther comprises a network connection operable to receive score data.

30. A data structure, comprising:
a score, the score comprising symbols representing sounds that are interpretable in a computerized wagering game machine to play the sounds represented in the score.

31. The data structure of claim 30, the data structure farther comprising network routing information.

32. The data structure of claim 30, further comprising at least one symbol representing a control signal indicating a desired state of a peripheral device of the wagering game machine.

33. The data structure of claim 30, wherein the score comprises musical instrument digital interface (MIDI) data.
